(19) United States
(12) Patent Application Publication
(10) Pub. No.: US 2011/0090072 A1
(43) Pub. Date: Apr. 21, 2011

(54) Auxiliary tow lighting with versatile gripping apparatus and method

(76) Inventor: Paul Haldeman, Murrietta, CA (US)

(21) Appl. No.: 12/589,186

(22) Filed: Oct. 20, 2009

(51) Int. Cl. G08B 21/00

(52) U.S. Cl. 340/431

(57) ABSTRACT

A high-level auxiliary lighting unit for towed vehicles, such as a trailer (and/or the load carried on a trailer) includes a multi-function lamp having tail, stop, and turn signal lights. An adjustable connector carries this multi-function lamp relative to a non-marring temporary clamping device, and allows a user to attach the lamp to a trailer, for example, or to a load item, and to orient the lamp to be displayed at a high level and toward the rear of the trailer or other such towed vehicle. The clamping device allows the high-level auxiliary lighting unit to be temporarily attached to a load on a trailer, or to a part of the trailer itself, in order to improve visibility for the trailer and its load, and to possibly reduce rear-end collisions.

### BACKGROUND OF THE INVENTION

1. Field of the Invention

The present invention relates generally to an auxiliary lighting apparatus and method for a vehicle, and particularly relates to tow lighting that may be deployed at a high-level on a towed vehicle, such as a boat trailer, jet ski trailer, motorcycle trailer, utility trailer, or other such trailer or towed vehicle. The apparatus and method according to the present invention provides tail lights, turn signals, and brake lights which are visible at a high level (i.e., at an elevated location) of the towed vehicle. A versatile gripping or temporary mounting device allows the tow lighting to be placed where it will have the greatest effect to improve safety for the vehicle in tow. Thus, this invention provides versatile high-level auxiliary lighting for such towed vehicles which greatly improves safety because the lighting can be located high on the towed vehicle, or trailer, or on cargo carried on that towed vehicle, to be much more visible to following drivers.

Still more Particularly, this invention relates to such high-level auxiliary lighting which includes a versatile non-marring gripping mechanism (i.e., a versatile, non-marring temporary mounting device) which is adapted to attach or clamp to a variety of structures and surfaces, such as portions of a boat hull or boat superstructure, or to a jet ski, to a motorcycle, or to a structural part of a utility trailer, for example. This mounting device carries at one or more attachment features to which may secure an adjustable connector. The adjustable connector provides for selective orientation relative to the mounting device (both in elevation and azimuth—i.e., angle relative to the vertical and rotation) of a lamp assembly carried by the adjustable connector. The lamp assembly preferably includes a tail light, a turn signal, and brake light. Provisions are included for powering the lights within the lamp assembly, including connecting these lights to the ordinary tail lights of a trailer or tow vehicle according to one alternative; or powering the lights by batteries carried in the lamp assembly itself, and possibly effecting remote control from a tow vehicle.

2. Related Technology

Utility trailers, motorcycle trailers, boat trailers, and such other towed vehicles include tail lights, turns signals, and stop lights, which generally are mounted to the trailer at an elevation only a few inches above the road surface. Usually, these lights are carried in conventional lamp assemblies which are mounted to the chassis or frame of the trailer. Because of the low mounting of these lamps, they are not easily visible even to the driver of a vehicle immediately behind the towed vehicle or trailer. Even worse, the drivers of vehicles behind the first following vehicle have no chance of seeing the lights on the trailer. And, on occasion, drivers of vehicles following trailers and other towed vehicles tend to follow much too closely, perhaps out of impatience or hoping for a chance to pass. Thus, rear end collisions are a great risk for towed vehicles and trailers.

One way in which towed vehicles are provided with auxiliary lighting is employed commonly by automobile towing companies. These conventional tow-company auxiliary lamps are commonly provided with a magnetic base which attaches to the sheet steel body of a towed automobile. In the case of a towing company having to tow a vehicle with a non-magnetic body, such auxiliary lamps having a suction cup base can be employed. Alternatively, a light-bar having auxiliary lamps mounted to it and a cushioned base is sometimes simply tied or strapped to the vehicle in tow. However, both the magnetic-base and suction cup-base type of auxiliary lamps require at least a limited area of flat surface on the towed automobile to which they may be secured. The light-bar arrangement of auxiliary lighting is generally not favored by modern towing companies because of the risk that the bar even with its cushioned base may damage or scratch the finish of the vehicle in tow.

For towed vehicles such as boat trailers carrying a boat, jet ski trailers with jet skis on board, utility trailers, and motorcycle trailers, for example, neither the trailer chassis, nor the items carried on these trailers provides a convenient surface or structure to which conventional auxiliary lighting may be secured by magnets or suction cups. Thus, such towed vehicles and trailers are generally left with only low-level, chassis-mounted lighting, and the safety of towing these types of trailers and their loads (i.e., boats, jet skis, cargo, and motorcycles, for example) is not as good as could be desired.

Thus, a need exists to provide improved high-level auxiliary lighting on towed vehicles, and by the use of such high-level auxiliary lighting to possibly improve highway safety by reducing rear-collision accidents involving this category of vehicle.

### SUMMARY OF THE INVENTION

In view of the deficiencies of the conventional related technology, it is an object of this invention to overcome or reduce one or more of these deficiencies.

Accordingly, one particularly preferred embodiment of the present invention provides a temporary high-level lighting unit particularly for use on a towed vehicle, or upon a load carried by a towed vehicle, the high-level lighting unit comprising: a temporary mounting device which is particularly adapted to attach or clamp temporarily to a variety of structures and surfaces; an attachment structure carried by the temporary mounting device, the attachment structure allowing for removable attaching thereto of an adjustable connector; the adjustable connector providing for selective manual orientation relative to the temporary mounting device in both elevation and azimuth of a lamp assembly, and the adjustable connector retaining such orientation for the lamp assembly; the lamp assembly including a light controllable from a tow vehicle; whereby, the lamp by controlled emission of light provides information about the towed vehicle or about the tow vehicle to drivers of following vehicles so that highway safety possibly may be improved.

Other objects, features, and advantages of the present invention will be apparent to those skilled in the art from a consideration of the following detailed description of a preferred exemplary embodiments thereof taken in conjunction with the associated figures which will first be described briefly.

### BRIEF DESCRIPTION OF THE DRAWING FIGURES

FIG. 1 provides a perspective view of a trailer, or towed vehicle, having conventional rear lighting mounted to the trailer chassis or frame, and also having high-level auxiliary lighting according to this invention temporarily mounted to an elevated location on the trailer.

FIG. 2 provides a diagrammatic circuit schematic of wiring for providing electric power to the auxiliary trailer lighting seen in FIG. 1;

FIGS. 3 and 4 are respective front and rear perspective elevation views of an auxiliary lamp according to this invention;

FIG. 5 provides a front perspective view of a the first embodiment of auxiliary lamp embodying the present invention, with the apparatus having been reconfigured;

FIG. 6 is a front perspective view of an alternative embodiment of an auxiliary lamp according to this invention; and

FIG. 7 provides a perspective and diagrammatic view of a use of the high-level lighting apparatus according to this invention.

### DETAILED DESCRIPTION OF EXEMPLARY PREFERRED EMBODIMENTS OF THE INVENTION

While the present invention may be embodied in many different forms, disclosed herein are specific exemplary embodiments which illustrate and explains the principles of the invention. In conjunction with the description of these embodiments, a method of providing auxiliary lighting on a vehicle according to this invention will be apparent. It should be emphasized that the present invention is not limited to the specific embodiments illustrated.

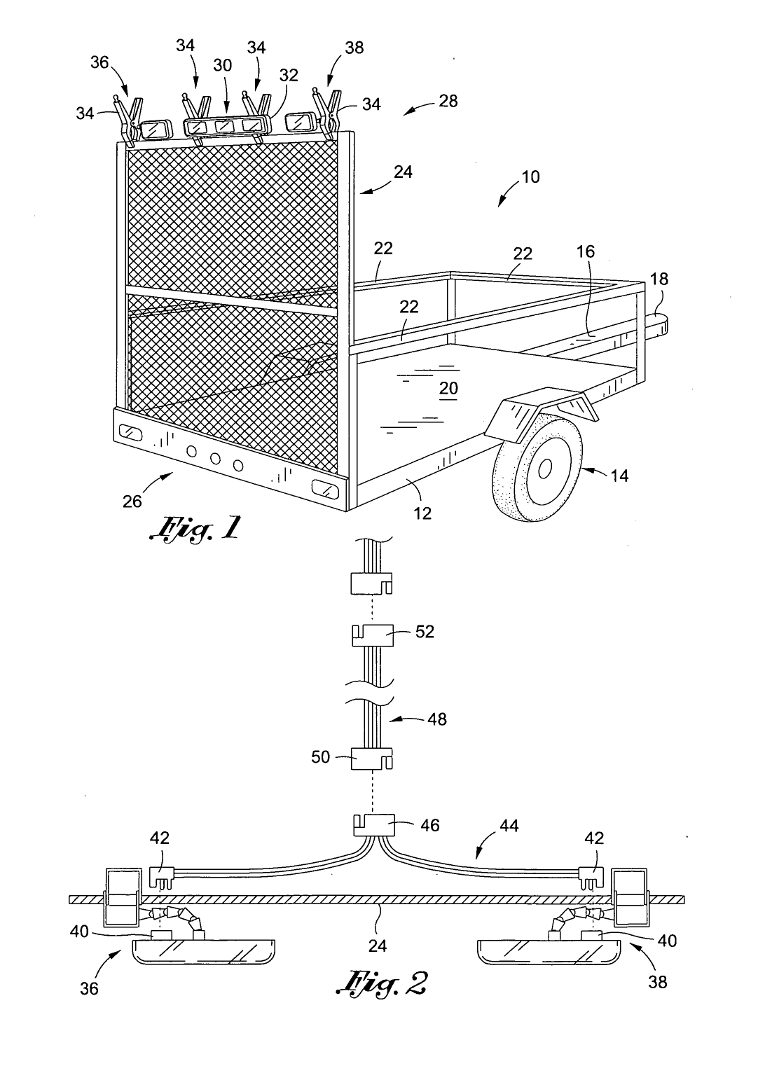

Viewing FIG. 1, a utility trailer 10 of conventional design includes a chassis 12 carried on wheels and tires 14, and including a trailer tongue 16 terminating at a trailer hitch 18 for attachment to a tow vehicle (not seen in the drawing Figures). The trailer chassis includes a utility floor 20 surrounded on the front and both sides by a safety rail 22 for carrying a load (also not seen in the drawing Figures). At the rear, the trailer 10 includes a drop-down gate/ramp 24 for allowing a load to be rolled up or down the gate/ramp to and from the floor 20. Conventional rear lighting, generally indicated with the arrowed numeral 26 is carried at the rear of the chassis 12. As can be seen in the illustration of FIG. 1, the conventional lighting 26 is located just a few inches above the road surface upon which the trailer 10 would be traveling when towed.

However, trailer 10 is also provided with high-level auxiliary lighting according to this invention, which is generally indicated with the numeral 28. The high-level auxiliary lighting 28 includes a centrally located identification lamp assembly 30 including a lamp housing 32 secured to the top edge of the gate/ramp 24 by a pair of spaced apart non-marring clamps, generally indicated with the numeral 34. The high-level auxiliary lighting 28 also includes respective left 36, and right 38 combination tail, stop, and turn signal lamp assemblies. These combination lamp assemblies 36 and 38 are also secured to the top edge of the gate/ramp 24 each by a respective non-marring clamp, also indicated with the numeral 34. Because of their high location, the auxiliary lighting 28 is much more visible to following drivers than is the conventional rear lighting 26.

Attention to FIG. 2 provides a schematic illustration of one means by which the high-level auxiliary lighting 28 may be provided with power from a tow vehicle. The lamp assemblies 36 and 38 each include a connector portion 40 disposed on the rear of each lamp assembly, and to which a mating connector 42 may connect. The mating connectors 42 are provided as parts of an auxiliary wiring harness generally indicated with the numeral 44. Near the center of wiring harness 44, a connector 46 provides for attachment and electrical connection of a cable 48 having a connector 50 at its rear end and matching with the connector 46. At the forward end of cable 48 is located another connector 52 which is configured to be compatible with the trailer-lighting connector provided on a tow vehicle.

Because the centrally located identification lamp assembly 30 is optional (dependent on whether the trailer 10 exceeds a certain width indicated in traffic laws and regulations), an additional connector (not illustrated in the drawing Figures) for this identification lamp assembly can be plugged into and between the connectors 46 and 50, rather than plugging these connectors directly to one another. Accordingly, the high-level lighting 28 is powered directly from a tow vehicle and operates as does the conventional lighting 26. It will be understood that as an alternative to powering the high-level lighting 28 directly from a tow vehicle, each lamp assembly of the auxiliary lighting may be under remote control. That is, each lamp assembly of the auxiliary lighting 28 may include a battery with a remote control switching device for operating the lights under radio control. And, the tow vehicle may include a radio transmitter interfaced with the rear lighting of the tow vehicle in order to affect corresponding operation of the remote controlled high-level auxiliary lighting 28.

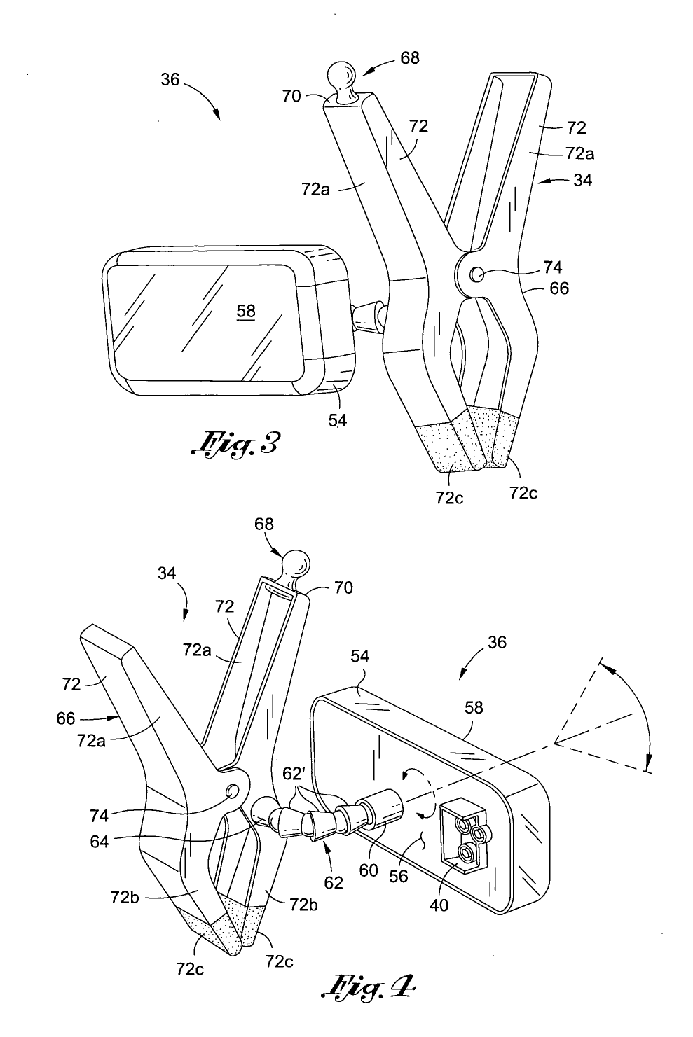

Turning now to FIGS. 3 and 4 considered in conjunction with one another, it is seen that a left and right combination tail, stop, and turn signal lamp assembly 36/38 are the same as one another, so that hereinafter the reference numeral 36 collectively refers to both lamp assemblies 36 and 38. Combination lamp assembly 36 includes a housing 54 disposing connector 40 on its rear face 56. At its front, housing 54 carries a lens 58 behind which are disposed the lights for tail, stop, and turn signal functions. Also disposed on the rear face 56 of housing 54 is a mount member 60 for attaching a multi-link or multi-section adjustable connector, collectively indicated with the numeral 62. The adjustable connector 62 includes plural ball-and-socket sections 62′ which are each relatively adjustable for rotation through a full 360° (indicated by a circular arrow on FIG. 4), and are adjustable for relative angle through a determined angle of about 45° to possibly a little more than 50° (indicated by an arcuate arrow on FIG. 4). The ball-and-socket sections of adjustable connector 62 are each preferably made of weather and sun light resistant engineering polymer, and are formed so that they socket together tightly. That is, each section of the adjustable connector 62 may be moved in angle and rotation relative to its neighboring section by the application of sufficient manual force. But, once the adjustable connector 62 is thus adjusted, the sections of this connector are sufficiently tightly engaged with one another that the connector 62 is relatively stiff and holds its adjustment against considerable force. The connector 62 is more than stiff enough to support the lamps 30 and 36 even against wind forces when the trailer 10 is in motion. Thus, an adjustable connector 62 of as few as four sections (or 4 ball-sockets) is (as is indicated best in FIG. 4) adequate to allow the lamp 36 to pivot in each direction at least through a full 90° relative to the clamp 34. As this Figure illustrates, the clamp 34 is provided by a clamp assembly 66, and a first ball stem base part 64 is carried on a side of this clamp assembly 66.

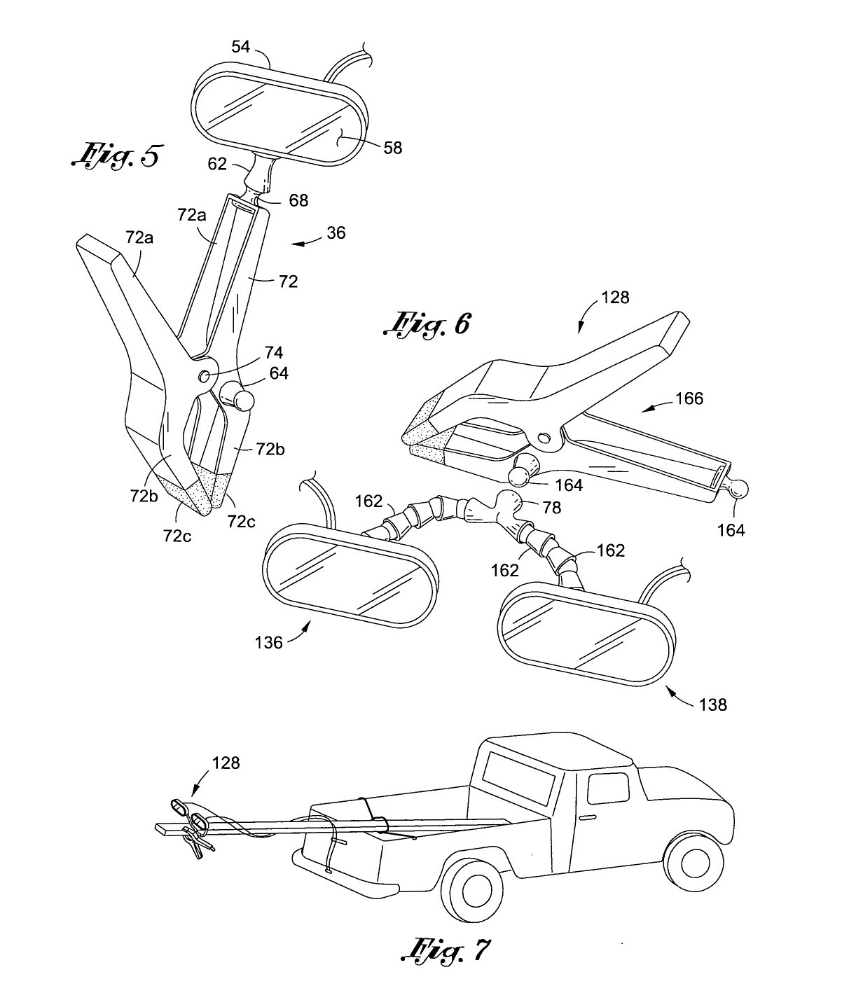

As will be noted viewing FIGS. 3 and 4, the clamp assembly 66 includes a first ball stem base part 64 disposed on the side of this clamp assembly 66, and also carries a second ball stem base part 68 which is attached to or formed integrally with a distal end 70 of a handle/jaw unit 72 of the clamp assembly 66. A separating and pressing tool (not seen in the drawing Figures) may be employed to disconnect the connector 62 from its position seen in FIGS. 3 and 4, and to connect this connector in the position seen in FIG. 5. Thus, the high-level lighting of this invention offers considerable flexibility and adaptability in its configuration and in the trailers and trailer load items (i.e., boats, jet ski's, motorcycles, etc.) to which the high-level lighting may be mounted.

Now giving further consideration to FIGS. 3 and 4, it is seen that the clamp assembly 66 includes a pair of pivotally interconnected handle/jaw units 72, which are the same except for one of them including the ball stem bases 64 and 68. In fact, both of the handle/jaw units 72 may be the same, and each may include one or both of the ball stem bases 64, 68. These handle/jaw units 70 are pivotally interconnected by a pivot pin 74, about which is trained a coil spring (not visible in the drawing Figures) urging the handle portions 72a of the units 72 apart while simultaneously urging the jaw portions 70b toward one another. The jaw portions 72b each carry a non-marring cushion or pad portion 72c. Also, the handle/jaw units 72 are themselves preferably formed of a weather and sun light resistant engineering polymer, which would be unlikely to mar or scratch the hull of a boat or jet ski, and is also unlikely to scratch the paint of a motorcycle, for example. Thus, the clamps 66 are generally non-marring, and the pad portions 72c are especially effective to make the clamps 66 non-slip in their engagement with a portion of a motorcycle, boat hull, or jet ski, for example. In the case of the example illustrated in FIG. 1, the clamps 66 are engaged with the upper marginal edge portion of the gate/ramp 24, and they very securely mount temporarily to this part of the gate/ramp.

As will be well understood in view of the disclosure above, in preparation for mounting the high-level lighting as seen in FIG. 1, the user manually twists and orients the lamp housings 54 relative to the clamps 66 so that the lenses 58 are oriented rearwardly relative to the trailer 10. Once the clamps 34 (i.e., clamp assemblies 66) are attached to the trailer, the wiring harness 44 is run between the lamps 36, with the connectors 40 and 42 being attached to one another. If a central identification lamp 30 is employed, it also is mounted to the towed vehicle (i.e., a trailer, for example) or to a load item on the trailer, and its connector is attached to connector 46. Then, the cable 48 is connected and extends to the trailer lighting connector of the towing vehicle. It will be apparent in view of the above that the lamp assemblies 36 and 38 are the same, and that the one which functions as a left turn signal, while the other functions as a right turn signal, is determined by the connections within the harness 44 and cable 48. So, the harness 44 has a left-hand end and a right-hand end which is positioned and connected appropriately relative to the trailer 10. As thus provided with high-level lighting, the trailer is towed as any ordinary trailer, but provides improved safety because of the greater visibility of the high-level lighting provided by this present invention.

Turning now to FIG. 5, the high-level lighting unit 36 is illustrated with the adjustable connector attached to a distal end of one of the handle/jaw units 72a. This configuration of the high-level lighting unit 36 has an advantage in that the lamp portion may be elevated a little more above the level of the trailer or load to which the lamp is mounted. Also, in those cases in which the load or trailer provides only a surface or feature to which the clamp part 34 is mountable in an orientation not favorable to the configuration of FIGS. 1-4, the configuration of FIG. 5 may allow satisfactory mounting of the high-level lighting unit 36.

Considering now FIG. 6, a unique construction of high-level lighting unit is disclosed as an alternative embodiment of this invention. This high-level lighting unit has many features which are the same as, or which are analogous in structure or function to, featured illustrated earlier and described above. Accordingly these familiar features are indicated on FIG. 6 with the same numeral used above, but increased by one-hundred (100). Turning now to FIG. 6, it is seen that a high-level auxiliary lighting unit 128 includes a pair of combination tail, stop, and turn signal lamp assemblies 136, 138, which are essentially the same as the lamp assemblies 36 and 38 described above. Attaching to the rear face of each of the lamps 136, 138 is a respective multi-link or multi-section adjustable connector, indicated with the numeral 162. Like the adjustable connectors 62, the connector 162 includes plural ball-and-socket sections 162′ which are each relatively adjustable for rotation through a full 360°, and are also adjustable for relative angle through a determined angle. However, in this embodiment, the two adjustable connectors 162 at their ends distal to the lamps 136, 138 connect with a Y-connector 78. The Y-connector 78 is attachable to either one of the ball-stem bases 164 provided on the clamp assembly 166.

As FIG. 7 illustrates, the embodiment of FIG. 6 has a great utility. This embodiment may be used as illustrated to add high-level lighting 128 to a long load which overhangs the rear of a vehicle. The versatile gripping mechanism or temporary mounting device allows the auxiliary lighting to be employed on a wide variety of towed vehicles, or on loads carried on such towed vehicles. The safety of towing such vehicles can thus be improved by use of this invention. And the embodiment of FIG. 7 may also be employed to add auxiliary lighting to a long or over-hanging load, and may also be used on a towed vehicle or on a load carried on such a towed vehicle.

Those skilled in the art will further appreciate that the present invention may be embodied in other specific forms without departing from the spirit or central attributes thereof. Because the foregoing description of the present invention discloses only particularly preferred exemplary embodiments of the invention, it is to be understood that other variations are recognized as being within the scope of the present invention. For example, it is apparent that the ball-and-socket adjustable connector structure can be re-arranged. That is, for example, the ball-stem bases can be replaced by ball-socket bases with the function of the apparatus remaining essentially unchanged. Also, the alternative clamping or gripping devices such as C-clamps, and locking pliers will suggest themselves to those ordinarily skilled in the pertinent arts. Such substitutions are apparent and are intended to be within the scope of the appended claims. Accordingly, the present invention is not limited to the particular embodiments which have been described in detail herein. Rather, reference should be made to the appended claims to define the scope and content of the present invention.

I claim:

1. A temporary high-level lighting unit particularly for use on a towed vehicle, or upon a load carried by a towed vehicle, said high-level lighting unit comprising:
a temporary mounting device which is particularly adapted to attach or clamp temporarily to a variety of structures and surfaces;
an attachment structure carried by said temporary mounting device, said attachment structure allowing for removable attaching thereto of an adjustable connector;
said adjustable connector providing for selective manual orientation relative to the temporary mounting device in both elevation and azimuth of a lamp assembly, and said adjustable connector retaining such orientation for said lamp assembly;
said lamp assembly including a light controllable from a tow vehicle;
whereby, said lamp by controlled emission of light provides information about said towed vehicle or about said tow vehicle to drivers of following vehicles so that highway safety possibly may be improved.

2. The temporary high-level lighting unit of claim 1 wherein said temporary mounting device includes a clamp member having a pair of separable jaws and means for opening and forcefully closing said separable jaws.

3. The temporary high-level lighting unit of claim 1 wherein said clamp member includes a hinged pair of jaws cooperatively defining a hinge axis, and said means for opening said jaws includes each one of said pair of jaws having a respective handle portion, and said means for closing said pair of jaws including a spring trained about said hinge axis.

4. The temporary high-level lighting unit of claim 3 wherein said clamp member carries a pair of said attachment structures, one of said pair of attachment structures being disposed on a side of said clamp member, and a second of said pair of attachment structures being disposed on a distal end of said handle portion of said clamp member.

5. The temporary high-level lighting unit of claim 1 wherein said attachment structure includes a structure selected from the group consisting of a ball stem base, and a ball socket base.

6. The temporary high-level lighting unit of claim 1 wherein said adjustable connector includes a train of ball-and-socket elements mutually inter-engaged with one another to provide rotational and angular adjustability relative to one another, and said ball-and-socket elements being sufficiently tightly engaged with one another that they resist relative movement except upon application of strong manual force.

7. The temporary high-level lighting unit of claim 1 wherein said adjustable connector also carries a second lamp assembly which is adjustably positionable relative to said temporary mounting device.

8. The temporary high-level lighting unit of claim 1 further including a second temporary mounting device also carrying a respective adjustable connector, and said second temporary mounting device and respective adjustable connector cooperatively supporting said lamp assembly.

9. A method of providing temporary high-level lighting on a vehicle, said method comprising steps of:
providing a temporary mounting device which is particularly adapted to attach temporarily in association to the vehicle;
providing an attachment structure carried by the temporary mounting device and allowing for removable attaching thereto of an adjustable connector;
extending the adjustable connector to a lamp assembly supported thereby, and also utilizing the adjustable connector to allow selective manual orientation relative to the temporary mounting device in both elevation and azimuth, while providing for the adjustable connector to retain a selected orientation for the lamp assembly;
including in the lamp assembly a light controllable so as to provides information about the vehicle.

10. The method of claim 9 further including the steps of providing for the temporary mounting device to includes a clamp member having a pair of separable jaws and means for opening and forcefully closing the separable jaws.

11. The method of claim 10 including the steps of providing the clamp member with a hinged pair of jaws cooperatively defining a hinge axis, and a respective handle portion extending opposite to the jaws, and providing a resilient element biasing the pair of jaws forcefully toward one another.

12. The method of claim 3 further including the steps of providing for the clamp member to carry a pair of the attachment structures, disposing one of the pair of attachment structures on a side of the clamp member, and disposing a second of the pair of attachment structures on a handle portion of the clamp member.

13. The method of claim 9 further including the steps of utilizing a train of tightly mutually engaged ball-and-socket elements as the adjustable connector.

14. The method of claim 9 further including utilizing the adjustable connector to also carry a second lamp assembly.

15. The method of claim 9 further including utilizing a second temporary mounting device and a respective second adjustable connector extending between the second temporary mounting device and the lamp assembly, so that the first-recited temporary mounting device and the second temporary mounting device cooperatively support the lamp assembly.

16. A temporary high-level lighting apparatus particularly for use on a towed vehicle, or upon a load carried by a towed vehicle, said high-level lighting apparatus comprising:
a temporary mounting device which is particularly adapted to attach or clamp temporarily to a variety of structures and surfaces, said temporary mounting device including a non-marring clamp with a pair of opposed jaws forcefully biased toward one another, and an opposite pair of extending handle portions allowing for said jaws to be manually opened;
an attachment structure carried by said clamp, said attachment structure allowing for removable attaching thereto of an adjustable connector;
said adjustable connector including a chain of inter-engaged tightly-fitting ball-and-socket elements cooperatively providing for selective manual orientation relative to the clamp in both elevation and azimuth of a lamp assembly carried at the distal end of said adjustable connector, and said adjustable connector retaining such selective orientation for said lamp assembly;
said lamp assembly including a light controllable from a tow vehicle;
whereby, said lamp by controlled emission of light provides information to other drivers so that highway safety possibly may be improved.

17. The temporary high-level lighting apparatus of claim 16 wherein said clamp carries a pair of lamp assemblies.

18. The temporary high-level lighting apparatus of claim 16 wherein said clamp carries a pair of said attachment structures allowing said attachment structure to be selectively positioned at either one of said attachment structures relative to said clamp.

19. The temporary high-level lighting apparatus of claim 17 wherein one of said attachment structures is disposed on a side of said clamp, and a second of said attachment structures is disposed at a distal end of a handle portion of said clamp.

20. The temporary high-level lighting apparatus of claim 16 including a second clamp carrying a respective second adjustable connector extending between said second clamp and said lamp assembly, whereby said clamp and said second clamp cooperatively support said lamp assembly.
